(19) United States
(12) Patent Application Publication
(10) Pub. No.: US 2026/0058559 A1
(43) Pub. Date: Feb. 26, 2026

(54) BI-DIRECTIONAL SWITCH FOR A SEMICONDUCTOR DEVICE

(71) Applicant: Cambridge GaN Devices Limited, Cambridge (GB)

(72) Inventors: Florin UDREA, Cambridge (GB); Di CHEN, Coquitlam (CA)

(21) Appl. No.: 19/306,018

(22) Filed: Aug. 21, 2025

(30) Foreign Application Priority Data
Aug. 22, 2024 (GB) 2412403.4

(51) Int. Cl. H02M 3/158; H02M 3/00

(52) U.S. Cl. CPC H02M 3/158; H02M 3/003

(57) ABSTRACT

A semiconductor device comprising a first control terminal configured to receive a first control signal; a second control terminal configured to receive a second control signal; and a bidirectional power transistor comprising a first gate terminal, a second gate terminal, a first terminal, and a second terminal, wherein the first gate terminal and second gate terminal are positioned between the first and second terminal, and wherein in use the first and second terminals are configured to operate as source or drain terminals of the bidirectional power transistor. The semiconductor device further comprises an interface circuit monolithically integrated with the bidirectional power transistor and operatively connected to the first control terminal, the second control terminal, the first gate terminal and the second gate terminal, wherein the interface circuit is an actively switchable circuit comprising one or more transistors.

### FIELD OF THE DISCLOSURE

The present disclosure relates to semiconductor devices. Particularly, but not exclusively, the disclosure relates to a bidirectional III-V high electron mobility transistor (HEMT) and its associated sensing, protection and regulation circuits.

### BACKGROUND OF THE DISCLOSURE

Gallium Nitride (GaN) is a wide band gap material with properties that make it a suitable candidate for use in several fields of application (e.g. radio-frequency electronics, opto-electronics, power electronics) which require solid-state devices.

GaN technology facilitates the design of transistors with high electron mobility and high saturation velocity. These properties of GaN have made it a good candidate for various high-power and high-temperature applications, for example microwave applications such as radar and cellular communications systems. As systems expand in subscribers and desired capacity, interest in increasing their operating frequency and power has grown correspondingly. Higher frequency signals can carry more information (i.e. have a greater bandwidth) and allow for smaller antennas with very high gain.

Additionally, GaN with its wide bandgap offers the potential for emitting light at higher frequencies for example the green, blue, violet, and ultraviolet portions of the electromagnetic spectrum.

In the last decade, GaN has increasingly been considered as a very promising material for use in the field of power devices. The application areas range from portable consumer electronics, solar power inverters, electric vehicles, and power supplies. The wide band gap of the material (Eg=3.39 eV) results in high critical electric field (Ec=3.3 MV/cm) which can lead to the design of devices with a shorter drift region, and therefore lower on-state resistance if compared to a silicon-based device with the same breakdown voltage.

The use of an Aluminium Gallium Nitride (AlGaN)/GaN heterostructure also facilitates the formation of a two-dimensional electron gas (2DEG) at the hetero-interface, where carriers can reach very high mobility (e.g. p=2000 cm2/(Vs)) values. In addition, the piezopolarization charge present at the AlGaN/GaN heterostructure, results in a high electron density in the 2DEG layer (e.g. 1×10¹³ cm⁻²). These properties allow the development of High Electron Mobility Transistors (HEMTs) and Schottky barrier diodes with very competitive performance parameters. An extensive amount of research has focused on the development of power devices using AlGaN/GaN heterostructures.

With the growth of power applications like electric vehicles, renewable energy generation, vehicle-to-vehicle communication, and energy storage, the demand for bidirectional switches is increasing. These switches enable the efficient control of energy flow in both directions, ensuring reliable and safe operation in various operating conditions. Emerging topologies may require power switches to have AC blocking capabilities, thereby increasing the requirement for bidirectional switches, for example:
1. Three-level converter topologies such as T-type NPC for PFC and inverter application; high power data centre power supply units with 3-phase input; and OBC/inverter for EV with 800V battery, all need a high voltage switch (VDS>650V) that can block AC in both directions.
2. AC-AC converters—such as AC Matrix converter or cycloconverter also need AC blocking capability.
3. Solid state Circuit breakers (SSCB) naturally need AC blocking and are a major application for bidirectional switches.

Traditionally back-to-back MOSFETs have been used for such applications. Monolithic bidirectional switches based on wide bandgap technologies can achieve high power conversion efficiency and are increasingly recognized as an industry standard for power electronics applications. Monolithic switches can reduce BOM cost and improve efficiency.

GaN lateral devices are inherently bidirectional due to the absence of p-n body diode. Based on the potential applied to the terminals, the current flows from the source to the drain or from the drain to the source in a similar manner. However, the blocking of the device is determined by the gate-to-drain separation distance, and this separation distance limits the application of this configuration for bidirectional applications. A conventional method of solving this problem is by making the gate-to-drain separation equal to the source-to-gate separation, thereby enabling the device to hold the same voltage from either side. The downside of this approach is that the device's cell pitch is increased. The other way to design a bidirectional switch while keeping cell pitch to minimum is by utilizing a dual gate structure. Generally, to achieve this, two devices may be connected in back-to-back configuration. This offers also the possibility of a more versatile control of the two gates rather than a single gate.

However, in specific cases two sets of isolated gate power supplies and two isolated gate drivers. Hence, the Applicant has therefore recognised a need for a more effective monolithic solution, a bidirectional semiconductor device capable of high current, low resistance, and high voltage applications with a reduced device count.

### SUMMARY

It is an object of the present invention to provide a bidirectional semiconductor device with integrated sensing, protection and regulation circuits.

According to a first aspect of the present disclosure there is provided a semiconductor device comprising:
a first control terminal configured to receive a first control signal;
a second control terminal configured to receive a second control signal;
a bidirectional power transistor comprising a first gate terminal, a second gate terminal, a first terminal, and a second terminal, wherein the first gate terminal and second gate terminal are positioned between the first and second terminal, and wherein in use the first and second terminals are configured to operate as source or drain terminals of the bidirectional power transistor; and
an interface circuit monolithically integrated with the bidirectional power transistor and operatively connected to the first control terminal, the second control terminal, the first gate terminal and the second gate terminal, wherein the interface circuit is an actively switchable circuit comprising one or more transistors, the interface circuit being configured to:
regulate a first voltage at the first gate terminal of the bidirectional power transistor; and
regulate a second voltage at the second gate terminal of the bidirectional power transistor.

Devices according to the present disclosure may provide some or all of the following advantages over a state of the art discrete device solution:
1. a smaller form factor and improved specific on-state resistance (i.e. resistance times area—which indicates the chip area a device occupies to achieve a target resistance) in comparison to two discrete dies.
2. Operations based on a single VDD, and a single regulation circuit to accommodate an external rail voltage, VDD to internal VDD voltages
3. Gate over voltage protection, overcurrent and short-circuit protections suitable for e.g. automotive power modules requirements. In implementations, the short-circuit protection mechanism can provide protection when either device section gets into saturation.
4. A simplified gate driver design, thereby reducing manufacturing costs and design constraints. For example, implementations of the device may have only one floating power supply with a ground referenced to a kelvin terminal, reducing or removing issues associated with the substrate voltage potential.

The bidirectional power transistor may be a bidirectional III-V HEMT.

The gate for an enhancement mode HEMT (i.e. with a positive threshold voltage) may comprise p-GaN gates, for example comprising a magnesium doped GaN region (e.g. acting as a p-type semiconductor) grown on top of an AlGaN layer. The gates may additionally comprise a Schottky or ohmic metallization in contact or in direct contact with the p-GaN region.

The gate for a depletion mode HEMT (i.e. with a negative threshold voltage) may comprise a Schottky metal deposited directly onto the AlGaN layer.

It will be understood that other suitable gate structures for enhancement and depletion mode HEMTs may also be utilised in conjunction with devices according to the present disclosure.

Both enhancement and the depletion mode HEMTs may be used as high voltage transistors, for example by scaling up the distance between the gate and the drain terminals where the voltage is supported during the blocking mode. Optionally, field plates may be provided to protect the gate and drain terminals and thereby reduce or minimise the electric field peaks at the drain and gate terminals respectively.

The first and second threshold voltage levels may be selected according to the needs and design requirements of the semiconductor device and/or its intended functionality or use. Preferably, the threshold voltages are selected to be sufficiently different to the maximum and minimum input voltages that the gates will not be turned ON or OFF due to signal noise or dV/dt events. For example, the threshold voltages may be between 1.5-5V.

The interface circuit may be partially or fully monolithically integrated with the bidirectional transistor. The interface circuit may provide various integrated sensing, protection and regulation functionality. In various implementations, the interface circuit comprises any one or more of:
Logic circuits;
Inverters;
Current sources;
Capacitors;
Two dimensional carrier gas (2DEG) or metal resistors;
Voltage limiters;
Voltage regulators;
Level shifters;
Short-circuit detection and protection circuits;
Clamping circuits;
Electro-static Discharge (ESD) circuits;
Current Sense transistors;
Overcurrent detection circuits; and/or
Overtemperature detection circuits.

These circuits and/or components may use low power or low voltage enhancement mode and depletion mode HEMTs, 2DEG (two dimensional electron gas) or metal based resistors, capacitors having insulating material as dielectric and different conductive layers as parallel plates. The enhancement mode low power/low voltage HEMTs may use a similar p-GaN gate to that used in the high voltage/power HENT. The depletion mode low power/low voltage HEMTs may use a Schottky based HEMT (as described above for the high voltage depletion mode HEMT).

In implementations, the bidirectional power transistor may comprise a third terminal positioned between the first gate terminal and the second gate terminal, the third terminal operatively connected to the interface circuit and configured to provide a reference voltage for the first gate terminal and the second gate terminal. It will be understood that, unlike in back-to-back to arrangements, the third terminal is not acting as a source or drain terminal as it does not provide carriers (source of electrons) or sink carriers (drain of electrons) during the steady-state conduction of the bidirectional switch. The third terminal may be used to provide a reference voltage. This terminal may be used as a Kelvin terminal and may be termed as voltage reference or mid-reference terminal.

In implementations, a metallisation area of each of the first and second terminals is at least five times greater than a metallisation area of the third terminal. For example, the first and second terminals may have a length of 5-10 micrometres, while the third terminal may have a length of 1-2 micrometres. This is facilitated by the fact that the third terminal does not take current in steady state, and therefore the contact resistance or electromigration due to excessive current densities within the metallization are not a significant concern in the operation of the device.

The third terminal may be a Schottky terminal. This means that the metallization of the third terminal may form a Schottky contact to the 2DEG layer below the terminal. Alternatively, the metallization layer may form an ohmic contact to the 2DEG below the terminal. Further alternatively, the third terminal may comprise a metallization placed onto a p-GaN region, optionally in a similar manner to the structure of one or more of the gate terminals.

In implementations, the third terminal may be operatively connected to a Kelvin terminal (or a Kevin reference terminal), and wherein the first and second control terminals are biased with respect to the Kelvin terminal. The semiconductor device may be configured such that a steady state current through the third terminal is zero or approximately zero (i.e. such that the current flow is either zero or comprises only a relatively small leakage current).

The bidirectional power transistor may comprises a substrate, the substrate comprising one or more of:
Silicon;
Silicon Carbide;
Sapphire;
Diamond;
Quartz;
Gallium Nitride; and/or
Semi-insulating Silicon Carbide.

Optionally, the bidirectional power transistor may further comprise a substrate metallization layer, wherein the substrate metallization layer is operatively connected to the third terminal.

The interface circuit may comprise:
a first Miller clamp transistor operatively connected between the first gate terminal and the third terminal; and
a second Miller clamp transistor operatively connected between the second gate terminal and the third terminal.

In implementations, the first and second terminals of the bidirectional power transistor may be separated in a first dimension; and the third terminal may comprise a plurality of third terminal regions, wherein the third terminal regions are separated from one another in a second dimension that is perpendicular to the first dimension.

Additionally or alternatively, the third terminal may extend above a surface of the bidirectional power transistor and/or into and below the surface of the bidirectional power transistor towards the substrate layer. In an implementation, the first and second terminals may extend into the second dimension, while the third terminal may extend into a third dimension that is perpendicular to the first and second dimensions. In such cases, the first and second terminals may have their greatest length dimensions in the second dimension, while the third terminal may have its greatest length dimension in the third dimension.

In implementations, the interface circuit may comprise one or more gate interface circuits. For example, the interface circuit may comprise:
a first auxiliary gate interface circuit configurable to adjust a voltage applied at the first control terminal to be operatively compatible with the first gate terminal, the first auxiliary gate interface circuit comprising:
a first low voltage auxiliary HEMT, the first low voltage auxiliary HEMT comprising
a first auxiliary HEMT source terminal, a first auxiliary HEMT drain terminal, and
a first auxiliary HEMT gate terminal; and
a first voltage limiter operatively connected to the first auxiliary HEMT gate terminal;
wherein the first auxiliary HEMT source terminal is operatively connected to the first gate terminal;
wherein the first auxiliary HEMT drain terminal is operatively connected to the first control terminal; and
wherein the first voltage limiter is operatively connected to the third terminal and to the first auxiliary HEMT gate terminal, and wherein the voltage limiter is configurable to limit a voltage across the first gate terminal and the third terminal; and

a second auxiliary gate interface circuit configurable to adjust a voltage applied at the second control terminal to be operatively compatible with the second gate terminal, the second auxiliary gate interface circuit comprising:
a second low voltage auxiliary HEMT, the second low voltage auxiliary HEMT comprising a second auxiliary HEMT source terminal, a second auxiliary HEMT drain terminal, and a second auxiliary HEMT gate terminal; and
a second voltage limiter operatively connected to the second auxiliary HEMT gate terminal;
wherein the second auxiliary HEMT source terminal is operatively connected to the second gate terminal;
wherein the second auxiliary HEMT drain terminal is operatively connected to the second control terminal; and
wherein the second voltage limiter is operatively connected to the third terminal and to the second auxiliary HEMT gate terminal, and wherein the voltage limiter is configurable to limit a voltage across the second gate terminal and the third terminal.

In implementations, the transistor may reference the gate terminals to the first or second (i.e. source or drain) terminals and not to a central terminal (i.e. third terminal). It will understood that such a configuration may not require a central third terminal. In such a configuration, the first and second terminals device may correspondingly be provided with separate interface circuits. In such implementations therefore the interface circuit may comprise:
a first interface circuit configured to regulate the first voltage at the first gate terminal of the bidirectional power transistor; and
a second interface circuit configured to regulate the second voltage at the second gate terminal of the bidirectional power transistor.

In this configuration, the first terminal may be configured to provide a reference voltage for the first gate terminal, while the second terminal may be configured to provide a reference voltage for the second gate terminal. Optionally therefore, the first interface circuit comprises a first Miller clamp transistor operatively connected between the first gate terminal and the first terminal; and the second interface circuit comprises a second Miller clamp transistor operatively connected between the second gate terminal and the second terminal.

Where first and second interface circuits are provided, each interface circuit may be provided with an auxiliary gate interface circuit. For example, the first interface circuit may comprise a first auxiliary gate interface circuit configurable to adjust a voltage applied at the first control terminal to be operatively compatible with the first gate terminal, the first auxiliary gate interface circuit comprising:
a first low voltage auxiliary HEMT, the first low voltage auxiliary HEMT comprising
a first auxiliary HEMT source terminal, a first auxiliary HEMT drain terminal, and
a first auxiliary HEMT gate terminal; and
a first voltage limiter operatively connected to the first auxiliary HEMT gate terminal;
wherein the first auxiliary HEMT source terminal is operatively connected to the first gate terminal;
wherein the first auxiliary HEMT drain terminal is operatively connected to the first control terminal; and
wherein the first voltage limiter is operatively connected to the first terminal and to the first auxiliary HEMT gate terminal, and wherein the voltage limiter is configurable to limit a voltage across the first gate terminal and the first terminal; and

the second interface circuit may comprise a second auxiliary gate interface circuit configurable to adjust a voltage applied at the second control terminal to be operatively compatible with the second gate terminal, the second auxiliary gate interface circuit comprising:
a second low voltage auxiliary HEMT, the second low voltage auxiliary HEMT comprising a second auxiliary HEMT source terminal, a second auxiliary HEMT drain terminal, and a second auxiliary HEMT gate terminal; and
a second voltage limiter operatively connected to the second auxiliary HEMT gate terminal;
wherein the second auxiliary HEMT source terminal is operatively connected to the second gate terminal;
wherein the second auxiliary HEMT drain terminal is operatively connected to the second control terminal; and
wherein the second voltage limiter is operatively connected to the second terminal and to the second auxiliary HEMT gate terminal, and wherein the voltage limiter is configurable to limit a voltage across the second gate terminal and the second terminal.

Where a substrate is provided a substrate metallization layer may be operatively connected to the first or second source terminals or floated between these two terminals. Optionally, the semiconductor device may further comprise a first substrate transistor operatively connected between the substrate metallization layer and the first terminal; and a second substrate transistor operatively connected between the substrate metallization layer and the second terminal. The first and second substrate transistors may be configured to selectively couple the substrate metallization layer to the respective first and second terminals.

In both configurations described above (first using a reference terminal and second without a reference terminal), the interface circuit may be configured to receive an external rail voltage (VDD) for the operation of the integrated sensing, protection and regulation circuits within the interface circuit. Alternatively, the interface circuit may comprise a start-up circuit configured to generate a rail voltage (VDD) from either the control terminal or the high voltage terminal (or both) for the operation of the integrated sensing, protection and regulation circuits within the interface circuit. For example, VDD voltage levels between 8-20 V may be applied externally, while the regulated maximum voltage level which should be used internally within the semiconductor device may be 7V.

In both cases, the interface circuit may optionally comprise a regulator circuit configured to regulate the control terminal voltages for the first and second gate terminals. For example, the regulator circuit may be configured to reduce an input voltage at either control terminal (of e.g. 0-20V) to an acceptable internal voltage level for the gates (e.g. p-type GaN gates) for the bidirectional transistor (e.g. 0-7V).

Where multiple interface circuits are provided, the interface circuits may comprise the same rail voltage or they may each comprise a separate rail voltage.

The semiconductor device may comprise an additional (e.g. fourth) terminal configured to report a fault signal when the interface circuit detects one or more of (i) a short-circuit, (ii) an overcurrent, and/or (iii) an over temperature event.

According to a second aspect of the invention, there is provided an inverter comprising at least one semiconductor device according to the first aspect. The inverter may be configured for use in a range of applications, including but not limited to electric vehicles (EV), electric motors, data centres, etc.

There may therefore be provided an EV comprising at least one semiconductor device according to the first aspect and/or an electric motor comprising at least one semiconductor device according to the first aspect.

### BRIEF DESCRIPTION OF THE DRAWINGS

The present disclosure will be understood more fully from the accompanying drawings, which however, should not be taken to limit the disclosure to the specific embodiments shown, but are for explanation and understanding only.

FIG. 1 shows an example bidirectional switch.

FIG. 2 shows a further example bidirectional switch.

FIG. 3 shows another example bidirectional switch.

FIG. 4 shows an example current flow through a bidirectional switch with a central reference terminal.

FIG. 5 shows an example current flow through a discrete device bidirectional switch.

FIG. 6 shows a top-view of an example bidirectional switch.

FIG. 7 shows a top-view of a further example bidirectional switch.

FIG. 8 shows an example bidirectional switch with an integrated sensing, protection and regulation interface.

FIG. 9 shows an example schematic circuit diagram of a bidirectional switch with an integrated sensing, protection and regulation interface.

FIG. 10 shows an example bidirectional switch with an example integrated sensing, protection and regulation interface configuration.

FIG. 11 shows an example bidirectional switch with another example integrated sensing, protection and regulation interface configuration.

FIG. 12 shows an example bidirectional switch with a further example integrated sensing, protection and regulation interface configuration.

FIG. 13 shows an example bidirectional switch with a further example integrated sensing, protection and regulation interface configuration.

FIG. 14 shows output characteristics of a bidirectional transistor in a first mode of operation.

FIG. 15 shows output characteristics of a bidirectional transistor in a second mode of operation.

FIG. 16 shows a bidirectional transistor in a third mode of operation.

FIG. 17 shows output characteristics of a bidirectional transistor in a third mode of operation.

FIG. 18 shows another example schematic circuit diagram of a bidirectional switch with an integrated sensing, protection and regulation interface.

FIG. 19 shows a schematic circuit diagram of an integrated sensing, protection and regulation interface with fault detection capabilities.

FIG. 20 shows an example bidirectional switch without a central reference terminal with an example integrated sensing, protection and regulation interface configuration.

FIG. 21 shows another example bidirectional switch without a central reference terminal with an example integrated sensing, protection and regulation interface configuration.

### DETAILED DESCRIPTION OF THE PREFERRED EMBODIMENTS

While many implementations described herein are depicted with the gates referred to the third terminal, it will be understood that the gates may instead be referred directly to the first and second terminal respectively. It will be understood that, in each of the implementations described herein, terminals referred to as sources or source terminals may instead be implemented as drains or drain terminals, and vice versa.

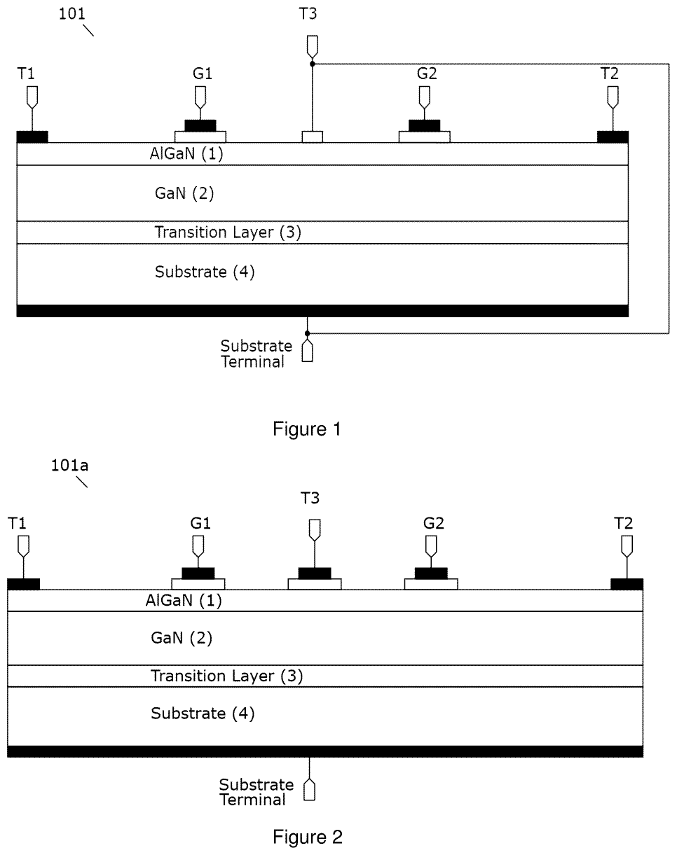

FIG. 1 illustrates an example of a bidirectional switch 101 comprising an enhancement mode III-V high electron mobility transistor (HEMT) switch comprising a first gate terminal (G1), a second gate terminal (G2), a first terminal (T1) acting as source or drain and a second terminal (T2) acting as drain or source respectively, over a single (shared) substrate 4. The first and second terminals are separated from one another in a first dimension. The enhancement HEMT switch additionally comprises a third terminal T3 (also referred to as a “mid-terminal” or “central terminal”) provided between the two gates. The terminals T1 and T2 may act as a source and drain or drain and source respectively based on the polarity of voltage bias on the terminals. The third terminal T3 is configured to provide a reference voltage to the gate terminals G1 and G2. T3 does not act as a source or drain of electrodes, and hence a steady state current through T3 is almost zero.

In the switch 101, the substrate 4 is connected to the third terminal T3, for example via a backside substrate terminal or metallisation layer. Alternatively, the substrate 4 may not have any metallization on the backside, and may not be connected to a substrate terminal. The substrate 4 may comprise or be formed from any suitable dielectric or insulating or semi-insulating materials. Examples of suitable substrate materials may include but are not limited to: silicon, sapphire, diamond, quartz, gallium nitride (GaN), silicon carbide (SiC), and/or semi-insulating silicon carbide.

A heterojunction is formed above the substrate 4 at an interface between AlGaN 1 and GaN 2 layers, providing a high electron density two dimensional carrier gas (2DEG). Optionally, a transition layer may be provided between the substrate 4 and heterojunction layers 1, 2.

The HEMT switch 101 may comprise multiple fingers or segments of the first and second terminals T1, T2. The fingers of the first and second terminals may be interdigitated such that the terminals alternate in the first dimension or a second dimension perpendicular to the first dimension.

In one example, the T3 terminal may comprise a Schottky contact. The Schottky contact may be similar to a Schottky gate structure generally used in a depletion mode HEMT.

A Schottky contact may provide an accurate reference voltage with respect to the gate terminals G1, G2, with very low leakage current in the T3 terminal (and in some implementations, a virtually zero leakage current). In another example, one or more of the T1, T2 and T3 terminals may comprise an ohmic contact.

FIG. 2 depicts a second example implementation of a bidirectional switch 101a. Switch 101a is similar to switch 101 of FIG. 1. However, in switch 101a, terminal T3 comprises a gate contact similar to the structure of gates G1 and G2. In an example, the gate contact may comprise a p-GaN layer.

It will be understood that, in all of the above examples, the function of T3 terminal is to act as a reference terminal to bias the gate terminals, or to otherwise provide the gate terminals with a reference voltage. This third terminal does not act as a source or drain of carriers (electrons).

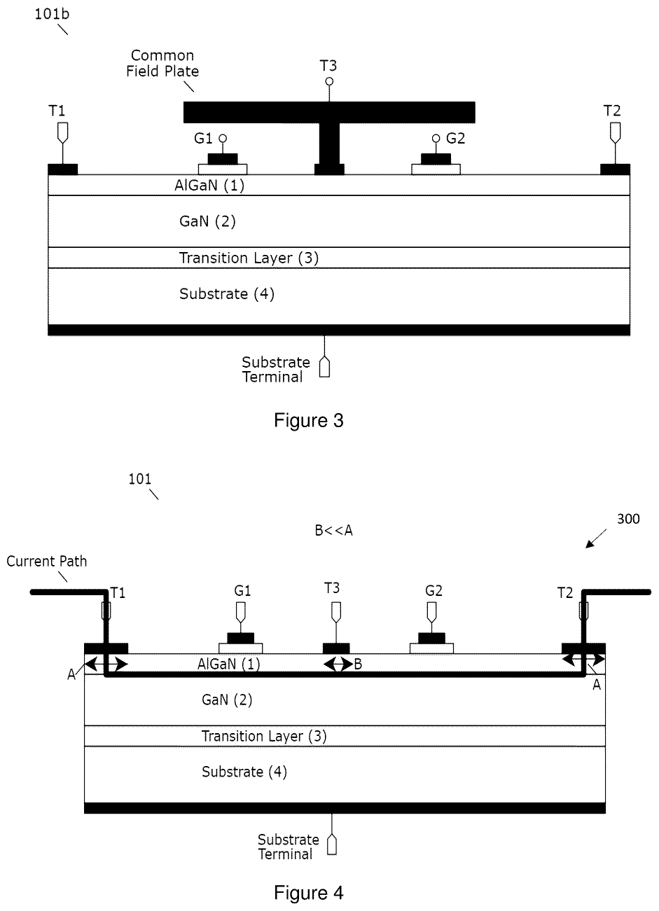

FIG. 3 depicts a bidirectional switch 101b. Switch 101b is similar to the switch 101 depicted in FIG. 1. However, in switch 101b a single common field plate (preferably connected to T3) is provided over G1 and G2 to protect both gate terminals (G1 and G2). It will be understood that common field plates may additionally or alternatively be provided for terminals T1 and/or T2.

FIG. 4 depicts an example path 300 for the current flow in a device such as switch 101. Assuming that the voltage at T2 is higher than the voltage at T1 and both gates (G1, G2) are ON, the current flows through the metallization of the first terminal (T1), the continuous 2DEG from the T1 terminal to the second terminal (T2) and through the metallization of T2 terminal. For current flow in this direction, the first terminal T1 functions as a source terminal, while the second terminal T2 functions as a drain terminal. It will be understood that as switch 101 is a bidirectional switch, current flow 300 may also be reversed, such that it flows from the T2 terminal to the T1 terminal (i.e. if the voltage at T1 is higher than the voltage at T2). Under such a reverse flow, the first terminal T1 instead functions as a drain terminal, while the second terminal T2 functions as a source terminal. Hence, it will be understood that T1, T2 may interchangeably function as source/drain depending on the direction of a current flow through the switch. It will be further understood that this applies equally to all other embodiments described herein.

A very small fraction of the current can also flow longitudinally through the third terminal T3, but minimal or ideally no current may flow vertically through the metallization of the T3 terminal. In other words, the T3 terminal is not used to conduct current, but instead only to set a potential to which the first and second gate terminals (G1 and G2) are referred to. The T3 terminal may therefore function as a reference terminal to bias the gate terminals or otherwise provide the gate terminals with a reference voltage.

In the depicted implementations, the substrate 4 is connected to the T3 terminal via a backside metallization. Because the metallization of the T3 terminal does not carry current vertically through it, the length (B) of the T3 terminal may be significantly smaller than length (A) of the T1 or T2 terminals. As an example, the length A of each of the T1, T2 terminals may be 5 to 10 μm, while the length B of the T3 terminal may be 1 to 2 μm. More generally, B and A may be any size, where B<<A, for example with the metallization area for the T3 terminal being at least 5× smaller than the metallization area provided for either of the T1/T2 terminals.

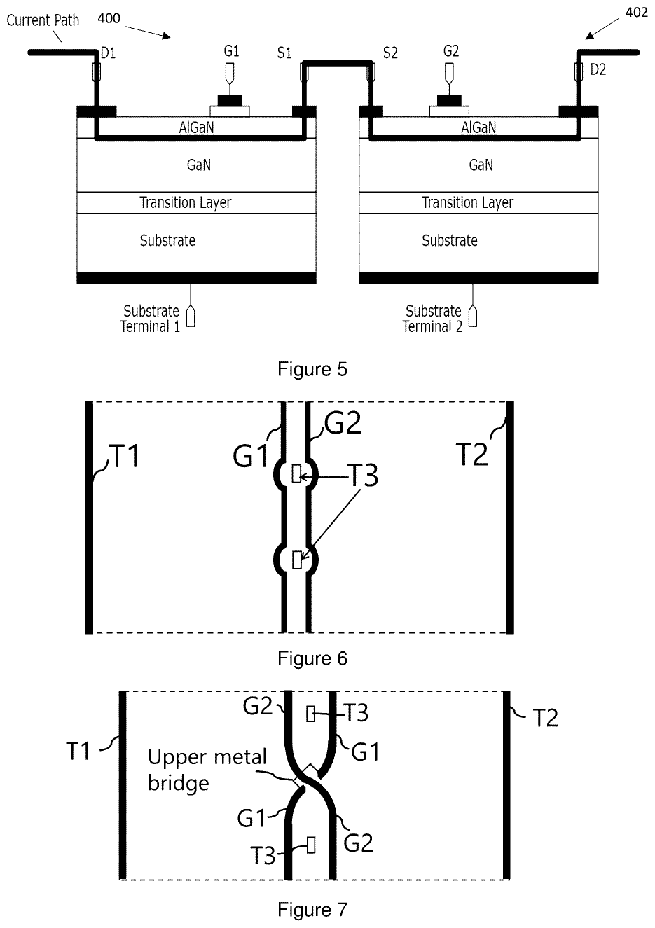

FIG. 5 depicts an example split substrate configuration of a conventional bidirectional switch 400. Switch 400 is comprises two back to back HEMTs comprising separate first and second source terminals (S1 and S2) and possibly formed on separate substrate layers or having different active areas (with different 2DEG layers). A current path 402 from the D1 terminal to the D2 terminal is depicted.

Such a discrete approach provides a simple solution to forming a bidirectional switch, e.g. by connection two existing transistors back-to-back. However, the current has a more convoluted path 402 than in switch 101, and this results in a larger on-state resistance. Current path 402 flows through the metallization of the D1 terminal, through the 2DEG between D1 and the first source terminal (S1), through the S1 metallization, an electric connection between S1 and the second source terminal (S2), then through the metallization of the S2 terminal, and the 2DEG formed between S2 and D2. In other words, and in contrast to current path 300, the current flows vertically through the metallization of the S1 terminal, and returns to the 2DEG by flowing vertically through the metallization of the S2 terminal. Thus, the metallization areas of all of the source and drain terminals need to be scaled to similar dimensions, to reduce the resistance changes through the current flow path and facilitate the flow of the current. For this reason, the discrete approach of switch 400 results in larger dimensions and/or higher on-state resistance when compared to a switch with a shared substrate such as that depicted in FIG. 1.

FIGS. 6 and 7 illustrate top-views of a bidirectional switch according to the present disclosure. As depicted in FIGS. 6 and 7, the third terminal T3 may optionally comprise a series of regions, fingers or islands. The islands are spaced apart from one another in a second dimension that is perpendicular to the separation direction (i.e. the first dimension) of the terminals T1/T2.

In FIG. 6, the gate terminals G1 and G2 are continuous and surround the multiple islands of the T3 terminal. As depicted in FIGS. 6, G1 and G2 are separated from one another in the same first dimension as T1 and T2 terminals.

In FIG. 7, the gate terminals G1 and G2 are interlaced around the islands of the T3 terminal.

Additionally or alternatively, the T3 terminal may be formed as multiple islands in the centre of the bidirectional switch with their length perpendicular to the length of the T1, T2 terminals. In other words, the third terminal and/or third terminal islands may extend into a third dimension that is perpendicular to the first and second dimensions. For example, and as depicted in FIGS. 6 and 7, the first and second terminals may extend in the second dimension, such that their greatest length dimension is in the second dimension. The third terminal and/or third terminal islands, by contrast, may extend “downwards” into the surface of the bidirectional switch or “upwards” away from the surface of the bidirectional switch, such that the greatest length dimension of the third terminal and/or third terminal islands is in the third dimension.

It will be understood that in other implementations of switches according to the present disclosure, the T3 terminal may comprise a single (continuous) region rather than multiple separate islands or regions.

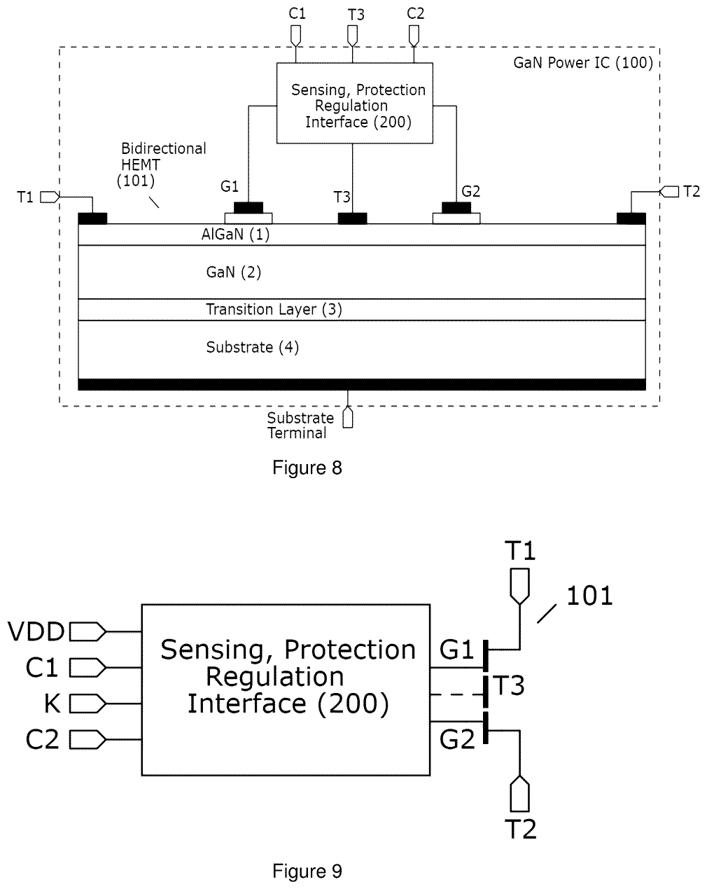

FIG. 8 illustrates an example power integrated chip (IC) 100 according to implementations of the present disclosure. The power IC 100 may be a GaN power IC, and may also be referred to as a semiconductor device. The power IC 100 comprises a high voltage lateral bidirectional transistor (e.g. a III-V HEMT, also referred to as a “power HEMT” or “bidirectional HEMT”) comprising two terminals T1 and T2 (also referred to as “first and second terminals”); two external gate electrodes C1 and C2 (also referred as “first and second external control terminals”) and a single reference electrode T3 (also referred to as a “third terminal” or “mid-terminal” or “central terminal”).

In the example power IC 100, the bidirectional transistor is depicted as bidirectional switch 101. Alternatively however, other suitable bidirectional transistors such as switches 101a or 101b may be used. It will be further understood that this applies equally to all other implementations described herein. It may further be understood that the first and second terminals may interchangeably function as drain or source terminals, depending on the flow direction of the current through the bidirectional switch 101.

A sensing, protection and regulation interface circuit (200) connects the external gate or control electrodes C1, C2 to the internal gate terminals G1, G2 of the switch 101. The sensing, protection and regulation interface may be monolithically integrated with the transistor 101. In implementations, the substrate terminal may be operatively connected internally (i.e. within the package) or externally (i.e. outside the package) to the third terminal T3.

One or both of the internal gate terminals G1 and G2 may comprise a pGaN region. The HEMT switch comprises a substrate 4, and may comprise one or more transition or nucleation layers 3 depending on the material of the substrate 4. For example, the substrate 4 may comprise silicon or silicon carbide. While most of the examples described herein refer to a silicon substrate, it will be understood that the present disclosure is also applicable to other semiconductors and/or substrate materials. As shown in FIG. 8, the HEMT switch may optionally comprise a substrate metallization or terminal, formed on a backside the substrate 4.

In the example of FIG. 8, a region 1 of III-V semiconductor material comprising aluminium (e.g. AlGaN) is formed on top of a layer 2 of GaN to form a heterostructure at the interface of the two layers, resulting in the formation of a two-dimensional electron gas (2DEG) at their interface. The 2DEG may facilitate the flow of current through a desired current path, for example as depicted in FIG. 4.

The sensing, protection and regulation interface 200 of the GaN power IC may incorporate (for example by monolithic integration) other devices and/or circuits, such as a Miller clamp HEMT (pull-down transistor), voltage regulators, current sources, current sense HEMTs, sensing load resistors, slew rate control circuits, dV/dt control circuits, drive circuits, logic circuits, short-circuit detection and protection circuits, over current and over temperature protection circuits, voltage clamping circuits, start-up devices/circuits, Electro-static Discharge (ESD) devices or circuits, capacitors, resistors and diodes (e.g. Schottky diodes or diodes made of a HEMT transistor by connecting the gate to one of its other terminals, source or drain). Examples of various such suitable circuits/devices as well as their uses and advantages are described in, for example, US2020/0168599, US2020/0357909, U.S. Ser. No. 10/818,786, US2021/0335781, and US2023/0131602, the contents of all of which are hereby incorporated by reference.

In implementations, the sensing, protection and regulation interface 200 is an active circuit, comprising at least one actively switched component such as a transistor.

FIG. 9 illustrates an equivalent schematic circuit diagram of a power IC such as power IC 100 of FIG. 8. The power IC may be represented as a single high voltage switch with two terminals (T1, T2) and two control terminals (C1, C2). Optionally, further terminals may also be provided, such as a DC low voltage rail terminal (VDD), a short-circuit detection terminal, a Kelvin reference (K) terminal and/or a current sense terminal. A Kelvin reference terminal may be connected to the third terminal (T3) and/or the substrate terminal(s) (not shown). The K terminal may be configured such that is does not conduct current during an on-state of the device (or may have a negligible current during the on-state), but instead acts as a voltage reference terminal to which control terminals C1 and C2 are biased against. For example, V_{G1}-V_{K} may be the gate-source potential drop controlling the 2DEG portion under the (p-GaN) G1 gate, while V_{G2}-V_{K} may be the gate-source potential drop controlling the 2DEG portion under the (p-GaN) G2 gate, where V_{G1} and V_{G2} are control signals provided to the G1/G2 terminals respectively, and V_{K} is a voltage of or supplied to the Kelvin reference terminal. It will be further understood that a Kelvin reference terminal may conduct current for short periods of time during transient signals.

The two external gate electrodes C1 and C2 may be driven by a single multi-output driver with two independent control signals, or via separate gate drivers each providing a control signal to one of the gates.

Each implementation shown in FIGS. 8 and 9 may benefit from common blocks used to control, sense and protect both gate terminals G1 and G2. For example, voltage regulator circuitry may be common to both internal gate terminals, and/or any short-circuit protection circuits may comprise components common to both gate terminals.

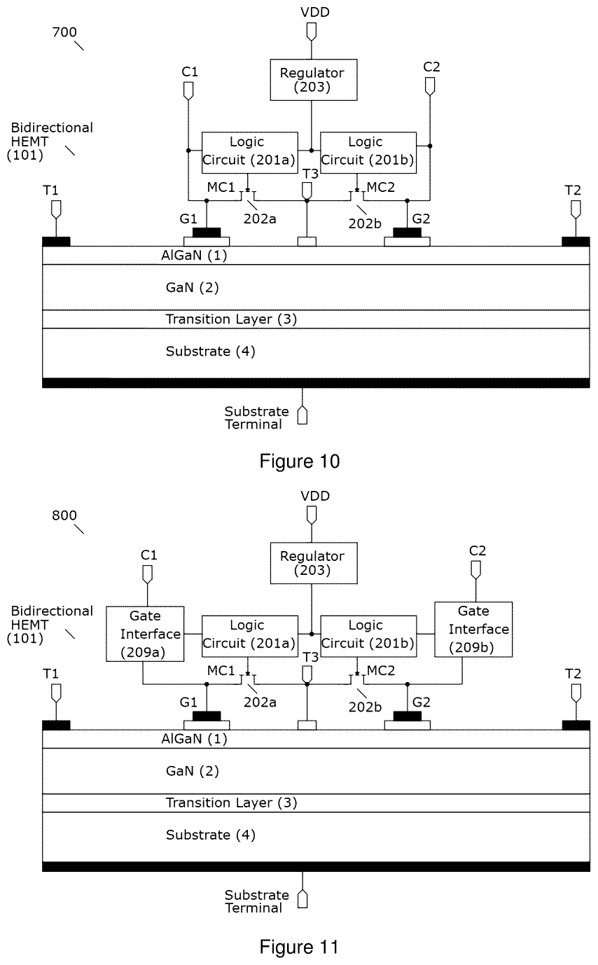

FIG. 10 illustrates a power IC 700 with an example sensing, protection and regulation interface. The sensing, protection and regulation interface comprises two Miller clamp transistors (e.g. pull-down HEMTs) 202a, 202b, one for each internal gate; two logic circuits 201a, 201b for driving respective Miller clamp transistors; and a shared voltage regulator for supplying voltage to the internal circuits of both the internal gates G1 and G2 such as the logic circuits etc. Some or all of these components may be monolithically integrated with the bidirectional HEMT 101. Additionally or alternatively, some or all of the sensing, protection and regulation interface components may be part of a separate chip (such as a silicon companion chip, or a driver chip), or otherwise provided externally to the power IC 700.

The Miller clamp transistors 202a,b may be “low-voltage” HEMTs, III-nitride transistors or any other suitable transistors. The Miller clamp transistors 202a and 202b may each be operatively connected between the respective internal gate (G1, G2) terminals and the T3 terminal of the bidirectional HEMT 101. The Miller clamp transistors may be normally-on transistors or normally-off transistors, or be a parallel combination of normally-on and normally-off elements. In other implementations, one or both of the Miller clamp transistors 202a, b may be a transistor as described in U.S. Ser. No. 11/404,565. The Miller clamp transistors may each act as a pull-down device to ensure a fast and safe turn-off, to thereby enhance immunity against transient voltage changes (dV/dt) and to reduce or avoid the need for applying negative gate voltages to turn-off a respective side of the bidirectional HEMT 101. During dV/dt events, displacement currents closing through the gate-drain capacitances may be sank to the T3 terminal by one of the Miller clamp transistors 202a or 202b. During such transient events, the T3 terminal (or a Kelvin reference terminal when the T3 terminal is directly connected to a Kelvin reference terminal) may conduct currents, even if it is configured to have no or minimal current flow during steady state operations.

The logic circuits 201a and 201b (which may also be referred to as Miller Clamp Drivers) may also be provided as part of an interface circuit. The logic circuits may comprise various components, such as a logic inverter configured to operate the actively switched Miller clamp transistors 202a, b. The logic inverter may comprise a resistor or resistive element (such as a load transistor or a current source) and an enhancement mode transistor. It will be understood that this is merely an example configuration, and other logic inverter designs could be utilised in place of or in addition to this configuration.

In operation, each logic circuit 201a,b is operatively connected to a respective external control terminals C1, C2. The C1 and C2 terminals are in turn configured to receive respective control signals from one or more gate drivers. When the control signal is high, the bias on the gate of the actively switched transistor in the respective Miller clamp transistor is low (and therefore its resistance is high), and vice versa.

As shown in FIG. 11, one or both of the logic circuits 201a, b may optionally be connected to the external control terminals C1, C2 via a respective gate interface circuit 209a,b. Each gate interface circuit 209a, b may be configured to enable the logic circuit to react to changes in the control signal before the deactivation of the respective Miller clamp transistor 202a,b, to thereby avoid or reduce loss of the gate current from the Miller clamp transistor to the voltage reference terminal.

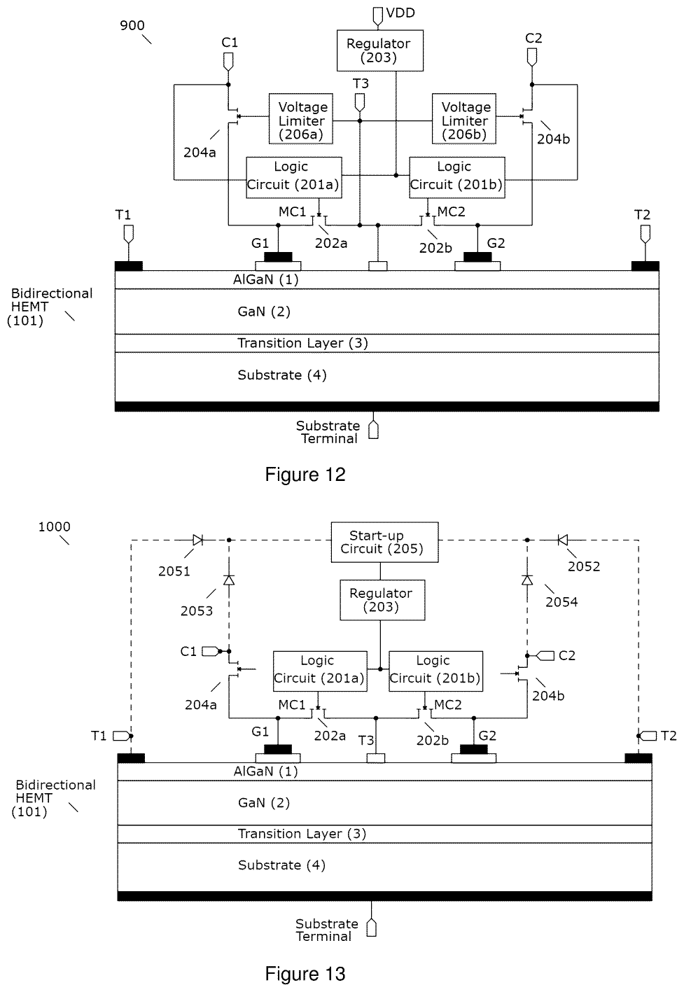

The regulator 203 is configured to adapt different DC voltages provided externally or internally via a start-up to levels that are suitable for the devices and/or circuits operated with the p-GaN gates G1, G2. For example, VDD voltage levels between 9-20 V may be applied externally, while the regulated maximum voltage level which should be used internally within the power IC 700 may be 7V. More than one regulated level can be provided for use internally via a suitable regulator circuit 203, for example as discussed in U.S. patent Ser. No. 11/955,478B2 and/or US patent application US2023/0131602. In one example, the logic circuits 201a, b are supplied by the output voltage of an integrated regulator circuit 203. Further, the input of the logic circuits 201a,b may be the output of the gate interface circuits 209a,b, limiting the voltage from the control terminals to a level that is optimised for the integrated GaN HEMT included in the logic circuits. FIG. 12 illustrates a power IC 900 comprising a further example sensing, protection and regulation interface configuration. The sensing, protection and regulation interface comprises two auxiliary GaN HEMTs 204a, 204b and two voltage limiters circuits 206a, 206b connected to the gate terminals of respective auxiliary GaN HEMTs 204a,b. As in power IC 700, the interface further comprises two Miller clamp transistors (e.g. pull-down HEMTs) 202a, 202b, one for each internal gate G1, G2; two logic circuits 201a, 201b for driving respective Miller clamp transistors; and a shared voltage regulator 203 for supplying voltage to the internal circuits of both internal gates G1, G2 such as voltage limiting circuits, logic circuits etc. Some or all of the components and circuits for this sensing, protection and regulation interface may be monolithically integrated with the bidirectional HEMT 101, to thereby provide lower parasitics, ease of manufacturing and faster reaction times. Alternatively, some or all of this interface may be provided as part of a separate chip (such as a silicon companion chip, or a driver chip). The combination of the auxiliary GaN HEMTs 204a,b and voltage limiters 206a, b may be referred as an auxiliary gate interface or gate interface, and may operate in a similar manner to the gate interface circuits 209a/209b shown in FIG. 11. It will be understood that the gate interface blocks may also include additional circuits or components.

The auxiliary GaN HEMTs 204a, b may each be a low-voltage device, wherein the respective gate G1, G2 of the high-voltage bidirectional HEMT 101 is connected to the source of the integrated auxiliary GaN HEMT 204a, b and the auxiliary GaN HEMT 204a, b has the drain connected to a respective control terminal (e.g. via external gate electrodes C1, C2) of the (GaN) power IC 900. Each auxiliary GaN HEMT 204a, b is configured to adapt the driving voltage of the respective control terminal to a voltage level suitable for the internal gates G1, G2 of the power HEMT 101. For example, the driving voltage on the control terminal could be from 0V to 20 V while the driving voltage seen directly by the gate terminal G1, G2 of the lateral high voltage bidirectional HEMT 101 may remain within a range of 0 to 7V. Optionally, a diode, a resistor or a parallel combination of both may be connected in parallel to one or both of the auxiliary GaN HEMTs, to act as a pull-down network during the turn-off of the overall configuration, and thereby connect the gate terminal of the active section of the bidirectional HEMT 101 to the ground.

The integrated voltage limiter 206a/206b may be connected between the respective external control terminals C1, C2, gate terminal of the auxiliary HEMT 204a, 204b, and the T3 terminal of the power integrated circuit 900. The voltage drop across the respective auxiliary GaN HEMT may therefore be non-linear when the voltage signal on the respective control terminal increases linearly. A low gate leakage current for the high voltage bidirectional HEMT 101 may be achieved by limiting the potential on the respective gate terminal G1, G2 of the bidirectional HEMT 101. This may be facilitated by allowing for a voltage drop across the integrated auxiliary gate interface block. The limit on the potential of the internal gate terminals may be defined by designing the voltage limiting circuit block 206a, b such that the gate of the auxiliary GaN HEMT 204a, b is pulled down when the gate signal on the control terminal of the power IC 900 increases beyond a threshold level. The gate voltage operation window of the power IC 900 (i.e. the voltage operation window applied to the control terminal) may therefore be increased compared to that of a conventional GaN HEMT.

As one example, the voltage limiting blocks 206a,b may each be composed of two resistors forming a potential divider and an actively switched low voltage enhancement mode transistor. The drain source path of the actively switched low voltage enhancement mode transistor may be connected between the respective internal gate and the T3 of the bidirectional HEMT. The potential divider may be connected between the respective control terminal (drain (gate) of the auxiliary GaN HEMT) and the T3 terminal of the bidirectional HEMT. The mid-point of the potential divider may be connected to the gate terminal of the low voltage enhancement mode transistor. The enhancement mode transistor can turn-on, and thus adjust the resistance between the internal gate terminal and the T3 terminal, when the voltage of the respective control terminal is raised above a certain (threshold) value, which can be controlled by the choice of resistors in the potential divider described. This function can protect the internal gate terminals from over-voltage events. Various other implementations of suitable voltage limiters are illustrated in U.S. patent Ser. No. 11/257,811B2.

Alternatively or additionally, a current source or resistors may be connected between the external gate terminals C1,C2 and the gates of auxiliary HEMTs 204a/204b.

Each voltage limiter 206a,b may be biased by the external control signals from the respective gate terminals C1, C2. Alternatively, the voltage limiters 206a/b could be biased from the VDD regulator 203, for example with a pull-down from the respective logic circuit 201a,b.

Since the auxiliary GaN HEMTs 204a, b may be low voltage devices, their source and drain terminal may be interchanged if they are formed in a symmetrical (or similar) way.

By a low-voltage device, it is meant a device that can typically have a rated breakdown below 20V, and a limited current capability (under 100 mA). However, it will be understood that the auxiliary gates 204a,b could alternatively be high power or high voltage devices.

FIG. 13 depicts a further example power IC 1000. Power IC 1000 is similar to power IC 900 of FIG. 12, but comprises an additional start-up circuit 205. Start up circuit 205 may be provided to reduce or avoid the need to apply an external VDD voltage for the operation of the interface circuit blocks. In this implementation, the voltage rail required by the interface circuit blocks may be generated internally through the start-up circuit 205 from either of the control terminals (e.g. via external gate terminals C1, C2) or via one or more of the terminals such as T1 or T2 (or a combination of the above). The start-up circuit 205 may comprise one or more of voltage regulators, voltage limiters, capacitors, depletion mode transistors, pass transistors and/or diodes. One or more of diodes 2051, 2052, 2053 and 2054 may be provided depending on the voltage rail is generated by the start-up circuit. For example, if the voltage rail is generated from the T1 terminal, diode 2051 may be provided. Voltage limiter blocks corresponding to voltage limiters 206a,b of power IC 900 are not shown in FIG. 13 for simplicity and clarity, however it will be understood that corresponding voltage limiter circuits may optionally be provided.

The power ICs illustrated in all the above embodiments may have various modes of operation, for example based on the potential at the first and second terminals (T1, T2) and the first and second gate terminals (G1, G2) of the high-voltage bidirectional HEMT 101.

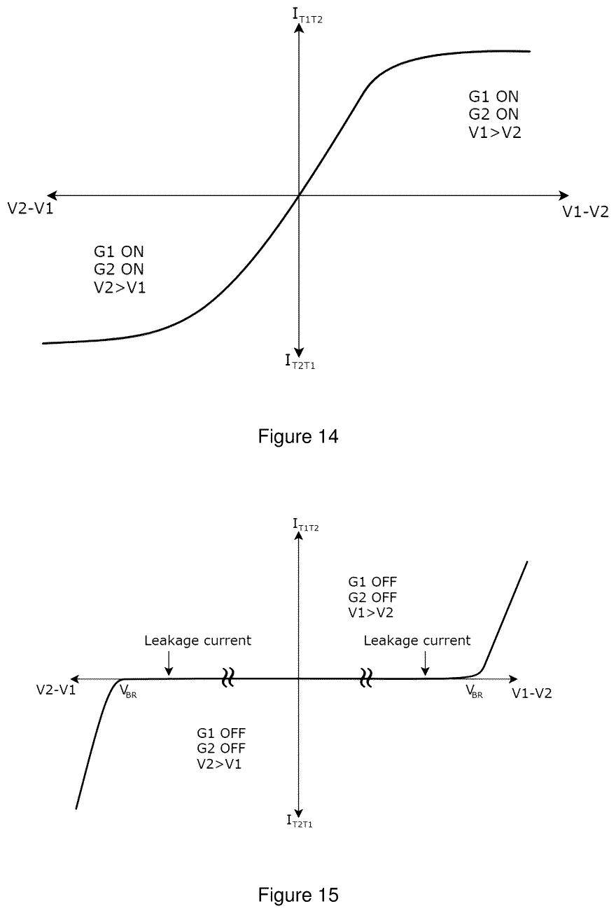

FIG. 14 illustrates the output characteristics of the bidirectional transistor in a first mode of operation, in which both the internal gate terminals G1, G2 are ON (HIGH). In such a scenario, 2DEG will be formed under both the gates and the relative potential of the first and second terminals T1, T2 will determine the direction of the flow of current. For example, if the voltage V1 at the first terminal is higher than the voltage V2 at the second terminal, then the current will flow from the first terminal T1 to the second terminal T2, and vice versa.

FIG. 15 illustrates the output characteristics of the bidirectional HEMT in a second mode of operation, in which both the internal gate terminals G1, G2 are OFF (LOW). This may happen when both the internal gates may have the same potential as the T3 terminal or are grounded by respective Miller clamp transistors. In such a scenario, both the sections of the bidirectional HEMT will not conduct any current, except for a (small) leakage current that may be present. When the voltage at any of the first or second terminals T1, T2 is greater than a breakdown voltage (V_{BR}) of the device, the bidirectional HEMT may enter into breakdown mode and conduct large amount of current. For example, for a device rate for 650V, the breakdown voltage may be in the range of 800V-1.2 kV.

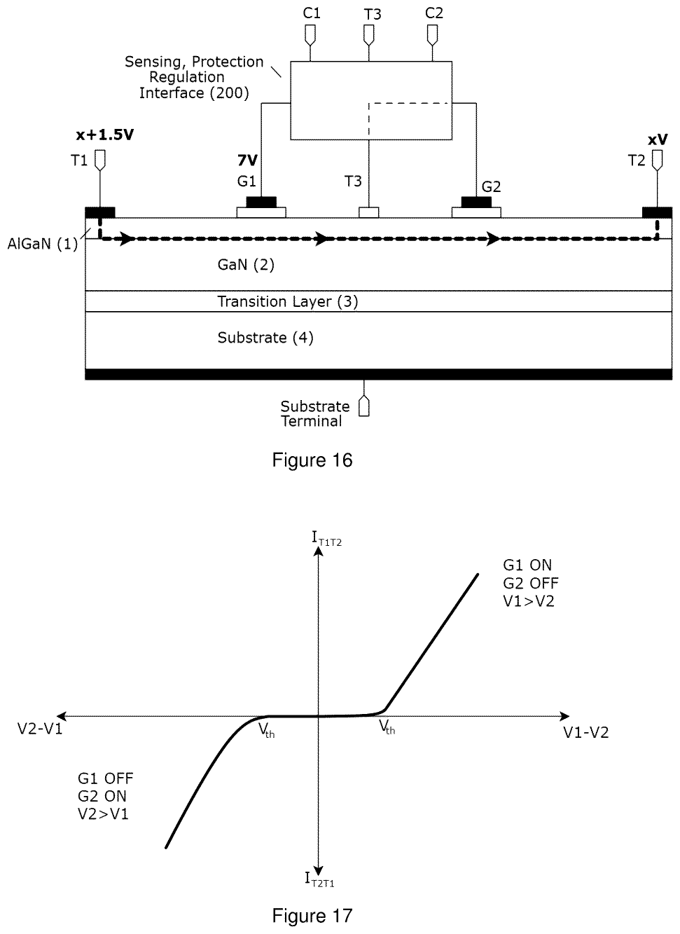

FIG. 16 illustrates a third mode of operation of the bidirectional HEMT where the first terminal T1 of the bidirectional HEMT is at a threshold voltage above the voltage of the second terminal T2. For example, if the threshold voltage of the transistor is 1.5V, a voltage V2 at the second terminal is xV and the voltage V1 at the first terminal is greater than x+1.5V. In this case, if the first gate terminal G1 is biased at a driving voltage above the T3 terminal (for example at 7V), then a 2DEG is present in the first section of the bidirectional HEMT under G2, ensuring conduction. At the same time, if the second gate terminal G2 is connected to the T3 terminal or pulled down by a Miller clamp transistor, then the second section of the bidirectional HEMT will operate as a diode as T1 is at a higher potential than T2. Therefore, the current in the device will flow from T1 to T2, e.g. as shown in FIG. 16. The device will operate in similar manner when V2>V1, G2 is ON and G1 is OFF. The output characteristics in this mode are shown in FIG. 17.

However, when the voltage V1 at first terminal is greater than voltage V2 at second terminal, the first gate terminal G1 is OFF and the second gate terminal G2 is ON, then the bidirectional HEMT will not be able to conduct current. In this scenario, the first section of the HEMT will be OFF as G1 is OFF and G2 will block the current from T1.

It may be understood that the power IC may be configured to operate in static or dynamic conditions in other modes that have not been illustrated above.

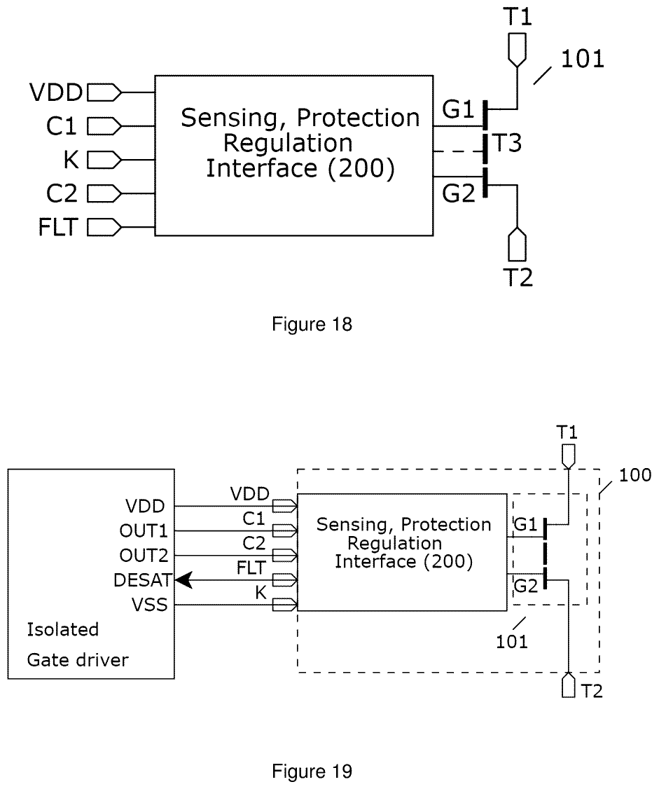

FIG. 18 illustrates a further equivalent schematic circuit diagram of a power IC such as power IC 100 of FIG. 8. For many topologies that use bidirectional switches, such as 3-Level NPC for inverter or SSCB (Solid state Circuit breaker), short-circuit protection and/or desaturation detection can be a mandatory design requirement for some intended use cases. As described earlier, the sensing, protection and regulation interface 200 of the GaN power IC could incorporate (e.g. monolithically integrated) sensing and protection circuits, such as Current sense HEMTs, Sensing load resistor(s), short-circuit detection and protection circuits, over current and over temperature (hotspot) detection and protection circuits, etc.

The switch may additionally or alternatively comprise a Fault Terminal (FLT) to enable the DESAT function for the external drivers. In automotive applications, gate drivers may be provided with a DESAT pin to provide a desaturation protection function. When the voltage at the DESAT pin exceeds a threshold voltage, the driver may initiate a safe-turn-off procedure to protect the power semiconductor switch. The FLT terminal of the bidirectional switch can be connected to the DESAT input of the gate driver.

The bidirectional switch can be operated with a single multi-output gate driver. However, conventional DESAT circuits can operate only with current flow in one direction, and therefore will not work with the reverse flow of current. Therefore, a traditional bidirectional switch would require two DESAT circuits for each direction of current flow, and correspondingly require two sets of drivers with DESAT functions. However, devices according to the present disclosure comprising the sensing, protection and regulation interface may be configured to internally detect the saturation of either section of the bidirectional HEMT, and logically combine the fault signals irrespective of the current flow direction or the section of the device, such that a single DESAT circuit may operate for both directions of current flow. However, it will be understood that individual gate drivers may be provided for each device gate G1, G2 if desired, and in such implementations each gate driver or set of gate drivers may be provided with its own DESAT circuit.

The sensing, protection and regulation interface 200 of the proposed GaN Power IC may incorporate a short-circuit detection and protection mechanism or circuit, for example as described in U.S. patent application Ser. No. 18/394,141. In such implementations, the drain to source voltage of both terminals T1, T2 can be sensed, and a combination of the two signals can be conditioned to generate a short-circuit detection signal (SCD), which can be output from the fault terminal.

In an implementation, the short-circuit detection circuit within the sensing, protection and regulation interface 200 may comprise: a voltage detection circuit configured to detect a voltage across the first, second terminals T1, T2 with respect to the T3 terminal and compare with a reference voltage. The voltage detection circuit further configured to output a high voltage detection signal when the voltage across any first or second terminal and the T3 terminal is above the reference voltage; and a blanking time circuit configured to output a blanking time signal after a blanking time period has elapsed. The short-circuit detection circuit may be configured to transmit the short-circuit detection signal based on the high voltage detection signal and the blanking time signal (e.g. based on a combination of the high voltage detection signal and the blanking time signal). For example, the short-circuit detection circuit may further comprise a logical combination circuit configured to receive the high voltage detection signal and the blanking time signal, and to output the short-circuit detection signal based on a combination of the high voltage detection signal and the blanking time signal. The short-circuit detection signal may be output from the FLT terminal. In one example implementation, the short-circuit detection signal may be received internally within the sensing, protection and regulation interface 200 at a Miller clamp transistor, to turn the Miller clamp transistor ON and pull down the gate voltage of the internal gate terminals. Additionally or alternatively, the short-circuit detection signal may be received at the gate interface circuit within the sensing, protection and regulation interface 200. The gate interface circuit may be configured, upon receipt of the short-circuit detection signal, to cause the voltage limiter to limit the voltage across the respective gate terminal and the T3 terminal to e.g. a lower gate voltage than during normal operation. For example, the voltage limiter may be caused to reduce the voltage across the respective gate terminal and the T3 terminal.

Alternatively, a hotspot based short-circuit detection methodology as described in U.S. patent application Ser. No. 18/394,078 may be used to generate the short-circuit detection signal (SCD) to be output from the fault terminal. The sensing, protection and regulation interface 200 may comprise a hotspot detection circuit and a protection circuit. The hotspot detection circuit comprising a temperature sensor (or temperature sensing device), the temperature sensor (or temperature sensing device) being configured to sense a localized temperature of the bidirectional HEMT. The hotspot detection circuit is configured, upon sensing by the temperature sensor (or temperature sensing device) of an increase in the localized temperature of the bidirectional HEMT, to transmit a hotspot detection signal to the FLT pin and additionally to the protection circuit and; and the protection circuit is configured, upon receipt of the hotspot detection signal, to cause a current between the T3 terminal and the T1, T2 terminal to be reduced, and/or the protection circuit may act on the bidirectional HEMT indirectly via one or more other components, circuits, or devices within the sensing, protection and regulation interface 200, and/or turn-off the bidirectional HEMT.

Thus, a single FLT pin can be interfaced directly to the DESAT pin on an external gate driver and report a short-circuit/overcurrent/overtemperature event, as shown in FIG. 19. In some examples, and during normal condition of the switch, the FLT may be actively pulled to ground. On the other hand, during fault condition, FLT pin can be floating (e.g. relying on an external pull-up resistor and a current source from the DESAT pin) or actively pulled up to HIGH to trigger the DESAT fault on the gate driver. The driver may in response turn-off the bidirectional HEMT or control the gate voltage at the control terminals to drive the switch according to the condition of the switch.

Such implementations of the semiconductor device may be particularly suitable for use cases requiring such fault detection and/or DESAT functions, such as bidirectional switches in automotive vehicle (e.g. for Electric Vehicles (EV) applications).

Alternatively, the semiconductor device may have more than one FLT terminal. As an example, there may be two FLT terminals to independently report a short-circuit/overcurrent/over-temperature event in either of the sections of the bidirectional HEMT, and in response control the respective gate voltage to drive the switch accordingly.

Alternatively, the FLT terminal of the device may be used for fault reporting even when the gate driver driving the switch may not have a DESAT pin. The FLT output may be interfaced with the general input/output of the controller (or signal processor or DSP) operating the gate driver. When a fault event may be reported through the FLT output to the controller, the controller may instruct the gate driver to control the driving voltage at the control terminals of the bidirectional switch. Optionally, the fault report may be communicated to the controller through a digital isolator or any other interface circuit needed by the controller to isolate the fault signal from the normal operation of the gate driver.

Additionally, or alternatively, the sensing, protection and regulation interface 200 may incorporate a feedback circuit. The feedback circuit may comprise at least one output operatively connected to a driver feedback input. The feedback circuit may be configured to provide a feedback signal to the driver feedback input, the feedback signal corresponding to a status of the semiconductor switch. For example, the feedback signal may correspond to the sensed current, sensed voltage, and/or sensed temperature in the semiconductor switch through the sensing circuits within the sensing, protection and regulation interface. The driver may be configured to adjust the driving voltage levels, frequencies of the driving voltage levels, slew rates, and/or timing sequences of the driving voltage levels based on the feedback signal.

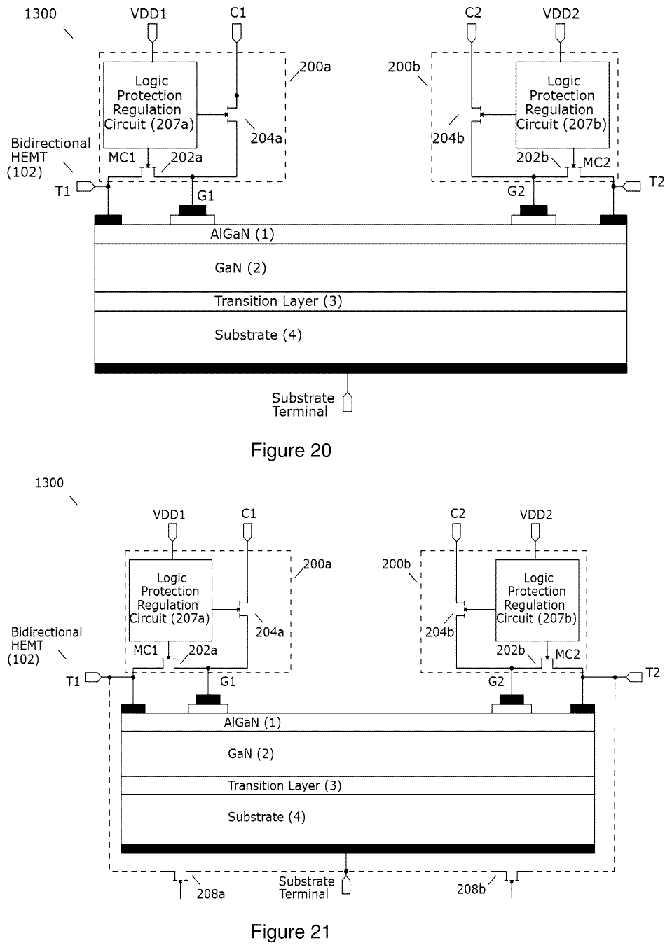

FIG. 20 illustrates a further example power IC 1300. in power IC 1300, a bidirectional HEMT 102 is provided with a second configuration where the bidirectional switch may be provided without a central (shared) third terminal between the two internal gates G1, G2. Instead, each of the first and second terminals T1, T2 may act as a reference voltage for their respective internal gates.

The semiconductor device 1300 (also referred to as a (GaN) power IC) in this embodiment comprises a high voltage lateral bidirectional transistor 102 (e.g. a III-V HEMT, also referred to as a “power HEMT” or “bidirectional HEMT”) comprising two main electrodes T1 and T2 (also referred to as “first and second terminals”); and two external gate electrodes C1 and C2 (also referred as “control terminals”). Current may flow through the device between the T1 and T2 terminals in a similar manner to current flow 300 depicted in FIG. 4. As such, it will be understood that each of the T1 and T2 terminals may function as a source terminal or a drain terminal depending on the direction of flow of the current through the bidirectional switch 102.

Two sensing, protection and regulation interfaces (200a, 200b) are provided, one for each of the T1 and T2 terminals. The interface circuits are respectively connected between the external gate electrodes, the internal gates G1 and G2, and the first and second electrodes/terminals T1, T2. The sensing, protection and regulation interfaces may be at least partially monolithically integrated with the transistor 102.

Each of the interfaces 200a, b may comprise any of the interfaces 200 described in earlier implementations, depicted here as respective logic, protection, regulation blocks 207a, b.

While the substrate 4 is depicted with a backside metallization layer, it will be understood that the substrate 4 may not have any metallization on the backside and may not connected to a substrate terminal. The substrate 4 may comprise or be formed of any suitable a dielectric or insulating or semi-insulating materials. Examples materials may include but are not limited to: silicon, sapphire, diamond, quartz, gallium nitride, silicon carbide or semi-insulating Silicon Carbide.

Optionally, as depicted in FIG. 21, the power IC 1300 may comprise high-voltage low-power transistors 208a, 208b operatively connected between the substrate terminal and each terminal T1 and T2, respectively, to provide selectable coupling of the substrate terminal to the respective terminal T1, T2 of the power device when operating as a source. This may facilitate the ability to bring the substrate potential to the source potential (e.g. ground), to a threshold voltage above ground, or to a low voltage when compared to the drain voltage when the respective side of the power device is in an on-state. Additionally, the transistors 208a,b may facilitate the selective decoupling (or operative disconnect) of the substrate potential from the respective source when the respective power device is in the off-state, to thereby reduce the off-state leakage through the substrate terminal.

The transistors 208a, 208b connected to each terminal T1, T2 may be driven through the respective gate signal or, alternatively, through an independent driving signal. One or both of the transistors 208a, 208b may be monolithically integrated with the bidirectional HEMT 102. In implementations, each transistor 208a, b may be formed through as a low power device through one finger each. Effective isolation of the substrate from the ground can further reduce the leakage current between the drain and the substrate, resulting in an improved breakdown voltage.

Alternatively, the transistors 208a/208b may be connected to the 2DEG or any other layer in the stack-up of the bidirectional HEMT 102, to facilitate top-side processing.

The skilled person will understand that in the preceding description and appended claims, positional terms such as ‘top’, ‘back’, ‘above, etc. are made with reference to conceptual illustrations such as those shown in the appended drawings. These terms are used for ease of reference but are not intended to be of limiting nature. These terms are therefore to be understood as referring to the positioning of the components as shown in the accompanying schematic drawings.

Although the disclosure has been described in terms of preferred embodiments as set forth above, it should be understood that these embodiments are illustrative only and that the claims are not limited to those embodiments. For example, circuits or blocks described with reference to a particular interface circuit may be incorporated into other interface circuit implementations. Those skilled in the art will be able to make modifications and alternatives in view of the disclosure which are contemplated as falling within the scope of the appended claims. Each feature disclosed or illustrated in the present specification may be incorporated in the disclosure, whether alone or in any appropriate combination with any other feature disclosed or illustrated herein.

Many other effective alternatives will occur to the person skilled in the art. It will be understood that the disclosure is not limited to the described embodiments, but encompasses all the modifications which fall within the spirit and scope of the disclosure.

1. A semiconductor device comprising:
a first control terminal configured to receive a first control signal;
a second control terminal configured to receive a second control signal;
a bidirectional power transistor comprising a first gate terminal, a second gate terminal, a first terminal, a second terminal, and a third terminal, wherein:
the first gate terminal and second gate terminal are positioned between the first and second terminal, and wherein in use the first and second terminals are configured to operate as source or drain terminals of the bidirectional power transistor; and
the third terminal is positioned between the first gate terminal and the second gate terminal, the third terminal operatively connected to the interface circuit and configured to provide a reference voltage for the first gate terminal and the second gate terminal; and
an interface circuit monolithically integrated with the bidirectional power transistor and operatively connected to the first control terminal, the second control terminal, the first gate terminal and the second gate terminal, wherein the interface circuit is an actively switchable circuit comprising one or more transistors, the interface circuit being configured to:
regulate a first voltage at the first gate terminal of the bidirectional power transistor; and
regulate a second voltage at the second gate terminal of the bidirectional power transistor.

2. The semiconductor device of claim 1, wherein a metallisation area of each of the first and second terminals is at least five times greater than a metallisation area of the third terminal.

3. The semiconductor device of claim 1, wherein the third terminal is operatively connected to a Kelvin reference terminal, and wherein the first and second control terminals are biased with respect to the Kelvin reference terminal.

4. The semiconductor device of claim 1, wherein at least one of:
the third terminal comprises a Schottky contact to the two dimensional electron gas below the third terminal; and
the third terminal comprises an ohmic contact to the two dimensional electron gas below the third terminal.

5. The semiconductor device of claim 1, wherein the third terminal is formed by a metal layer positioned over a p-GaN layer.

6. The semiconductor device of claim 1, wherein the bidirectional power transistor comprises a substrate and a substrate metallization layer, and wherein the substrate metallization layer is operatively connected to the third terminal.

7. The semiconductor device of claim 1, wherein the semiconductor device is configured such that a steady state current through the third terminal is zero or approximately zero while transient or displacement currents proportional to the rate of change of voltage of the first or second terminal with respect to time through the third terminal are zero or greater than zero.

8. The semiconductor device of claim 1, wherein the interface circuit comprises:
a first Miller clamp transistor operatively connected between the first gate terminal and the third terminal; and
a second Miller clamp transistor operatively connected between the second gate terminal and the third terminal.

9. The semiconductor device of claim 1, wherein the first and second terminals are separated in a first dimension; and
wherein at least one of:
(i) the third terminal comprises a plurality of third terminal regions, wherein the third terminal regions are separated from one another in a second dimension that is perpendicular to the first dimension; and
(ii) the third terminal extends into a third dimension perpendicular to the first and second dimensions, such that a greatest size dimension of the third terminal is in the third dimension.

10. The semiconductor device of claim 1, wherein the interface circuit comprises:
a first auxiliary gate interface circuit configurable to adjust a voltage applied at the first control terminal to be operatively compatible with the first gate terminal; and
a second auxiliary gate interface circuit configurable to adjust a voltage applied at the second control terminal to be operatively compatible with the second gate terminal.

11. The semiconductor device of claim 1, wherein the interface circuit is configured to receive an external rail voltage (VDD) to thereby provide a DC voltage to components and/or circuits forming the interface circuit, optionally wherein the semiconductor device comprises a regulator circuit configured to regulate the voltage supplied by the rail voltage to a suitable DC voltage to drive the circuits within the interface circuit.

12. The semiconductor device of claim 1, wherein the interface circuit comprises a start-up circuit configured to generate a rail voltage (VDD) to thereby provide a DC voltage to components and/or circuits forming the interface circuit, optionally wherein the semiconductor device comprises a regulator circuit configured to regulate the voltage supplied by the rail voltage to a suitable DC voltage to drive the circuits within the interface circuit.

13. The semiconductor device of claim 1, wherein the bidirectional power transistor comprises a substrate, the substrate comprising one or more of:
Silicon;
Silicon Carbide;
Sapphire;
Diamond;
Quartz;
Gallium Nitride; and/or
Semi-insulating Silicon Carbide.

14. The semiconductor device of claim 1, wherein the interface circuit comprises any one or more of:
a logic circuit;
an inverter;
a current source;
a capacitor;
two dimensional carrier gas (2DEG) or metal resistor;
a voltage limiter;
a voltage regulator;
a level shifter;
a short-circuit detection and protection circuit;
a clamping circuit;
an electro-static Discharge (ESD) circuit;
a current Sense transistor;
a overcurrent detection circuit; and/or
a overtemperature detection circuit.

15. The semiconductor device of claim 1, comprising an additional terminal configured to report a fault signal when the interface circuit detects one or more of (i) a short-circuit, (ii) an overcurrent, and/or (iii) an over temperature event.

16. The semiconductor device of claim 1, wherein the bidirectional power transistor is a bidirectional III-V HEMT.

17. A semiconductor device comprising:
a first control terminal configured to receive a first control signal;
a second control terminal configured to receive a second control signal;
a bidirectional power transistor comprising a first gate terminal, a second gate terminal, a first terminal, and a second terminal, wherein the first gate terminal and second gate terminal are positioned between the first and second terminal, and wherein in use the first and second terminals are configured to operate as source or drain terminals of the bidirectional power transistor; and
an interface circuit monolithically integrated with the bidirectional power transistor and operatively connected to the first control terminal, the second control terminal, the first gate terminal and the second gate terminal, wherein the interface circuit is an actively switchable circuit comprising one or more transistors, the interface circuit comprising:
a first interface circuit configured to regulate a first voltage at the first gate terminal of the bidirectional power transistor; and
a second interface circuit configured to regulate a second voltage at the second gate terminal of the bidirectional power transistor.

18. The semiconductor device of claim 17, wherein:
the first terminal is configured to provide a reference voltage for the first gate terminal; and
the second terminal is configured to provide a reference voltage for the second gate terminal.

19. The semiconductor device of claim 17, wherein:
the first interface circuit comprises a first Miller clamp transistor operatively connected between the first gate terminal and the first terminal; and
the second interface circuit comprises a second Miller clamp transistor operatively connected between the second gate terminal and the second terminal.

20. The semiconductor device of claim 17, wherein the bidirectional power transistor comprises a substrate and a substrate metallization layer, and wherein the substrate metallization layer is operatively connected to at least one of the first and second terminals;
optionally wherein the semiconductor device comprises:
a first substrate transistor operatively connected between the substrate metallization layer and the first terminal; and
a second substrate transistor operatively connected between the substrate metallization layer and the second terminal;
wherein the first and second substrate transistors are configured to selectively couple the substrate metallization layer to the respective first and second terminals.

21. The semiconductor device of claim 17, wherein:
the first interface circuit comprises a first auxiliary gate interface circuit configurable to adjust a voltage applied at the first control terminal to be operatively compatible with the first gate terminal; and
the second interface circuit comprises a second auxiliary gate interface circuit configurable to adjust a voltage applied at the second control terminal to be operatively compatible with the second gate terminal.
